(19) United States
(12) Patent Application Publication
(10) Pub. No.: US 2009/0307067 A1
(43) Pub. Date: Dec. 10, 2009

(54) LOCATION BASED COUPON DELIVERY SYSTEM

(75) Inventor: Lance Obermeyer, Austin, TX (US)

Correspondence Address: John A. Fortkort;Fortkort & Houston P.C., Building 1, Suite 500, 9442 N. Capital of Texas Hwy, Austin, TX, 78759, US

(73) Assignee: 30 Second Software

(21) Appl. No.: 12/477,220

(22) Filed: Jun. 3, 2009

Related U.S. Application Data
(60) Provisional application No. 61/131,041, filed on Jun. 4, 2008.

(51) Int. Cl. G06Q 30/00; G01C 21/00; G06F 17/30

(52) U.S. Cl. 705/14.1; 701/213; 701/300; 705/27; 707/5; 707/104.1; 707/E17.044; 707/E17.018; 707/E17.017

(57) ABSTRACT

A system (101) is provided for presenting, to a user of a mobile device (111), coupons for products or services which are available at nearby stores. The system comprises (a) a catalog database (105); (b) a coupon database (107) containing a set of coupon offers, wherein each coupon offer is associated with a set of applicable items from the catalog database, and is further associated with a geographic region; and (c) a coupon server (103) adapted to receive location and item information from the mobile device via a network (109), and being further adapted to (i) search through the coupon database, (ii) evaluate coupons in the database for geographic relevance, (iii) select any coupons determined to be geographically relevant, and (iv) return the selected coupons to the mobile device.

### CROSS REFERENCE TO RELATED APPLICATIONS

This application claims the benefit of priority from U.S. Application No. 61/131,041, filed Jun. 4, 2008, having the same title, and having the same inventor, and which is incorporated herein by reference in its entirety.

### FIELD OF THE DISCLOSURE

The present disclosure relates generally to mobile communications devices, and more particularly to methods and systems for enabling users of these devices to receive contextually relevant coupon offers.

### BACKGROUND OF THE DISCLOSURE

Location-based services are well known to practitioners in the field. There are several generally accepted mechanisms to determine the location of a mobile device. The two leading methods are the Global Positioning System (GPS) and triangulation methods based on the location of nearby cell towers (Cell ID).

GPS is a satellite-based system where satellites continually broadcast information about their locations, and receivers receive these ephemeris broadcasts. The receivers then perform a triangulation calculation on the received location information to determine the point on earth where the device is located. The Cell ID method works by determining the location of the nearest cell towers. This is usually accomplished by determining the identifiers of the connected cell tower. These locations are then triangulated to determine a point on earth. Regardless of method, the device is able to determine its latitude and longitude within an acceptable degree of uncertainty.

Location information is exposed to users in a variety of well known ways, typically through some sort of mobile application. The most common application is to display a map indicating the location of the device. Map information is often augmented with a destination point and driving directions between the current location and the destination point. Other well known applications include asset tracking (such as tracking trucks through a delivery route) and “friend finder” applications (such as displaying the location of other devices).

Electronic commerce services are well known to practitioners in the field. In particular, it is well known to allow a mobile device to connect to an electronic commerce system. This connection is generally accomplished through the use of a “mobile browser”, which is the browser included in the mobile device. A given vendor may have a web site to which users from mobile browsers connect directly, or they may have a special web site which is optimized for the peculiar constraints of mobile browsers (such as reduced screen size). Alternatively, connection to a web site may be accomplished through a “rich application”, which is a software program executing on a device. In either case, the device has the ability to display a catalog of products to a user, and the user can browse the catalog and select specific products of interest.

In the physical world, vendors often distribute printed catalogs to prospective customers. These catalogs often include a set of products that the vendor sells. In order to increase the probability that a prospective customer will actually purchase something, the vendor often includes some sort of special offer. The special offer is normally in the form of a coupon. Depending on the purpose and redemption method of the coupon, it may be in the form of a printed item that is physically presented to the vendor for in-store purchases. Alternatively, the coupon may be a code that is verbally presented to the vendor for phone purchases, or that is typed into a form in the case of Internet orders. Typically, the coupon also has a tracking code that allows the performance of the coupon to be tracked.

### BRIEF DESCRIPTION OF THE DRAWINGS

FIG. 1 is an illustration of a system in accordance with the teachings herein.

### SUMMARY OF THE DISCLOSURE

In one aspect, a system is provided for presenting, to a user of a mobile device, coupons for products or services which are available at nearby merchants. The system comprises (a) a catalog database; (b) a coupon database containing a set of coupon offers, wherein each coupon offer is associated with a set of applicable items from the catalog database, and is further associated with a geographic region; and (c) a coupon server adapted to receive location and item information from the mobile device via a network, and being further adapted to (i) search through the coupon database, (ii) evaluate coupons in the database for geographic relevance, (iii) select any coupons determined to be geographically relevant, and (iv) return the selected coupons to the mobile device.

In another aspect, a method is provided for presenting, to a user of a mobile device, coupons for products or services which are available at nearby merchants. The method comprises (a) receiving location information and item information from a mobile device via a network, wherein the location information relates to the location of the mobile device, and wherein the item information relates to an item of interest to a user of the mobile device; (b) evaluating coupons in a coupon database for geographic relevance and user interest relevance, wherein the geographical relevance is determined from the location information, and wherein the user interest relevance is determined from the item information; and (c) returning to the mobile device coupons meeting a predetermined geographic relevance and a predetermined user interest relevance.

In a further aspect, a system is provided for presenting, to a user of a mobile device, coupons for products or services which are available at nearby stores. The system comprises (a) a network adapted to support communication between the mobile device and a server computer; (b) a mobile device which is adapted to connect to the network, and which is further adapted to determine its location; (c) a browser, resident on the mobile device, which is adapted to allow a user of the mobile device to browse a catalog over the network; (d) a catalog database containing of a set of products or services organized as a tree, wherein each node in the tree contains an identifier; (e) a coupon database containing a set of coupon offers, wherein each coupon offer is associated with a set of applicable items from the catalog database, and is further associated with a geographic region; and (f) a coupon server adapted to receive location and item information from the mobile device via the network, and being further adapted to (i) search through the coupon database, (ii) evaluate coupons in the database for geographic relevance, (iii) select any coupons determined to be geographically relevant, and (iv) return the selected coupons to the mobile device.

In a further aspect, a system is provided for presenting, to a user of a mobile device, coupons for relevant products or services, wherein relevancy is determined through a context aware combination of location and product selection.

In still another aspect, a method is provided for presenting, to a user of a mobile device, coupons for relevant products or services, comprising the step of determining the relevancy to the user of a coupon through a context aware combination of location and product selection.

### DETAILED DESCRIPTION

In addition to conventional coupons of the type described above, the use of mobile coupons has also become common in the art. Companies such as CellFire have implemented services that deliver such coupons to mobile devices. However, because these coupon deliveries are typically either catalog-based or location-based (but not both), they have limited contextual applicability. That is, all browsers of a mobile catalog may be presented the same offers, even if there is no nearby store. Likewise, all browsers of a list of nearby stores may be presented the same offers, even if it is for stores in which the user has no interest.

Many devices, such as the RIM BLACKBERRY®, Apple iPHONE® and Motorola RAZR® mobile communications devices, have the ability to determine where they are. This ability for “Location-Based Services” is well known and very popular, and is best exemplified by mapping and driving directions programs such as TELENAV®. Similarly, these mobile devices also have electronic commerce capability. This includes the ability to display a catalog of products or services. Specifically, users can view products at vendor web sites through the device's mobile browser or through a native application. Additionally, these devices have to ability to display a coupon. Coupons can be displayed in a variety of formats, such as in alphanumeric code or in a bar code.

The systems and methodologies disclosed herein link these three capabilities. Specifically, the systems and methodologies disclosed herein enable a mobile device to present context sensitive coupons to a user. These coupons have contextual relevance through a location that is close to the user and an item of interest from a catalog.

The object of the present disclosure is to present relevant coupon offers to users of location-enhanced mobile devices. Relevancy is enhanced through the context aware combination of location and product selection. Without wishing to be bound by theory, it is believed that the intersection of a user's desires (as expressed through product selection) and a user's location (as determined by the device) improve coupon targeting.

In the preferred embodiment, the location-based coupon delivery process comprises the following components:
1. Mobile device. The mobile device should include the ability to determine its location within a certain range. This may be achieved, for example, by receiving and processing GPS signals, by accessing and reporting the identifiers of one or more nearby cell towers that can be subsequently used to look up the location of the tower, or through other suitable techniques as are known to the art. The mobile device should also provide the user with the ability to browse a catalog and to select a category or item of interest from the catalog.
2. Mobile network. The mobile network should include the ability to allow mobile devices to connect to a catalog server and a coupon server.
3. Coupon server. The coupon server should include the ability to receive catalog information and location information from the mobile device and to respond with relevant coupon information. It should also include the ability to determine the relevancy of an offer to a user.
4. Catalog database. The catalog database preferably contains a set of products or services. Items in the catalog database preferably have an identifier.
5. Coupon offer database. The coupon database preferably contains a set of coupons.

The location-based coupon delivery process preferably begins with the user selecting an item from a catalog. The user may accomplish this by, for example, browsing a catalog which is stored either locally on the device or which is accessed over the mobile network. A catalog may be a category of items or a specific item. The coupon process is preferably initiated after the user selects the catalog item.

In a preferred embodiment, the coupon process comprises the following steps:
1. The mobile device determines its location. This may be accomplished, for example, through GPS-based geo-location, through Cell ID-based geo-location, by reusing a previously calculated location, or through another suitable mechanism.
2. The mobile device sends the catalog item identifier and location identifier to the coupon server. This communication is across the mobile network.
3. The coupon server receives the catalog item identifier and location information from the mobile device. The coupon server then determines whether there are any relevant coupon offers to present to the user. If there are one or more relevant coupon offers, the coupon server returns the coupon information to the mobile device.
4. The mobile device displays returned coupon information to the user.

### Coupon Server

The coupon server is the component responsible for determining whether there is a relevant coupon offer to present to a particular user. The coupon server preferably bases this decision, at least in part, on the following three factors:
1. The catalog item (category or product or service) being viewed by the user.
2. The location of the user. This may be expressed, for example, in latitude/longitude or through the use of another suitable geographical descriptor (such as zip code).
3. The set of available coupons in the coupon database.

The primary function of the coupon server is preferably to respond to [catalog item, current location] queries, where the response to the query is a potentially empty set of applicable coupons.

In the preferred embodiment, a catalog is organized as a tree. The root of the tree represents the entire catalog. From the root are branches that represent categories, which may themselves have an arbitrary number of child categories. Categories may represent any item from the domain, such as vendors (e.g., Barnes & Noble, Best Buy) or product types (e.g., Books, Electronics). The leaves of the tree are individual products or services. Thus, a catalog is a tree of arbitrary shape (organization). A catalog item is therefore an individual node in the tree, which may represent the entire catalog (if the selected node is the root), an individual product (if the selected item is a leaf), or a subset of the catalog (if the selected node is an interior node). Other catalog organization schemes are also possible.

An individual coupon is an offer such as “10% off”. A coupon may be attached to any node in the catalog tree, and is preferably applicable for that node and all descendents. Thus, attaching the coupon to the “Books” node implies that any book is eligible for the coupon offer.

A coupon is preferably also attached to a geographical predicate that defines the area in which the coupon is valid. For example, an offer may be valid only in a particular state or at a particular store. This may be represented by a state abbreviation (e.g., TX), a set of postal codes (e.g., 78730, 78746), a polygon bounded by latitude/longitude points, a radius around a latitude/longitude point, or through other suitable schemes.

In the preferred embodiment of the systems and methodologies disclosed herein, the geographic predicate of a coupon is represented as a predicate which is evaluated by the catalog server. The catalog server returns the value “true” if the location of the user is within the area described by the predicate, and returns the value “false” if the location of the user is not within the area described by the predicate. An offer that is applicable anywhere has the predicate “true;”, whereas an offer that is applicable only in a particular location has a predicate which specifies that location. Thus, for example, an offer which is valid only in Bee Cave, Tex. may have the predicate “zip==78738”.

### Example

Assume the following catalog, which is tree structured and which has an identifier for each node. The format is the identifier followed by the category name or item details. Indentation is used to indicate a parent/child relationship.

[catalog: 0] Root

-[catalog: 1] Books

--[catalog: 2] Fiction

--[catalog: 3] Non Fiction

---[catalog: 4] Cooking

----[catalog: 5] Italian Grill by Mario Batali, ISBN 9780061450976, $20.96

[catalog: 6] Electronics.

Assume the following three coupon offers. In each case, the coupon has an identifier, an offer, a catalog node, and a geographic predicate. The first coupon is applicable anywhere. The second coupon is applicable with a 10 mile radius of a store located at latitude/longitude 30.2920, −97.8267 (Westlake Hills, Tex.). The third coupon is applicable within a 10-mile radius of a store located at latitude/longitude 30.2920, −97.8267 (Round Rock Tex.).
-[coupon: 1] “10% off any book”, [catalog: 1], [true]
-[coupon: 2] “Free knife with any cookbook during in-store cooking demonstration”, [catalog: 4], [distance(30.2920, −97.8267)<10]
-[coupon: 3] “Free knife with any cookbook during in-store cooking demonstration”, [catalog: 4], [distance(30.5170, −97.6873)<10].

A preferred embodiment of the process flow is illustrated by the following particular, non-limiting example:
1. The user browses the catalog on their mobile device and navigates to the “Books” category.
2. The mobile device determines its location via GPS lookup. The location is determined to be 30.2742, −97.7406 (the Texas State Capitol building).
3. The mobile device sends the data [catalog: 2, location(30.2920, −97.8267)] to the coupon server.
4. The coupon server searches the database for coupon offers applicable for catalog node 2 and discovers there is one, which is [coupon: 1].
5. The coupon server determines whether the current position is within the geographic predicate for [coupon: 1]. Since the predicate is true, the coupon is accepted.
6. The coupon server returns the data [coupon: 1], “10% off any book” to the mobile device.
7. The mobile device displays the offer to the user.
8. The user ignores the offer and continues to browse the catalog, then navigating to Books, Non Fiction, Cooking, “Italian Grill” by Mario Batali.
9. The mobile device sends the data [catalog: 5, location(30.2920, −97.8267)] to the coupon server.
10. The coupon server searches the database for coupon offers applicable for catalog node 5 and discovers there are three, which are [coupon: 1], [coupon: 2], and [coupon: 3].
11. The coupon server determines whether the current position is within the geographic predicate for the [coupon: 1]. Since the predicate is true, the coupon is accepted. It then determines whether the current position is within the geographic predicate for the [coupon: 2]. To evaluate the predicate “distance(30.2920, −97.8267)<10”, the coupon server calculates that the distance between 30.2920, −97.8267 and 30.2920, −97.8267 is 5 miles. Since 5 miles is less than the 10 in the predicate, the coupon is accepted. It then determines whether the current position is within the geographic predicate for the [coupon: 3]. To evaluate the predicate “distance(30.5170, −97.6873)<10”, the coupon server calculates that the distance between 30.2920, −97.8267 and 30.2920, −97.8267 is 17 miles. Since 17 miles is greater than the 10 in the predicate, the coupon is rejected.
12. The coupon server returns the data [coupon: 1], “10% off any book” and [coupon: 2] “Free knife with any cookbook during cooking demonstration” to the mobile device.
13. The mobile device displays both offers to the user.

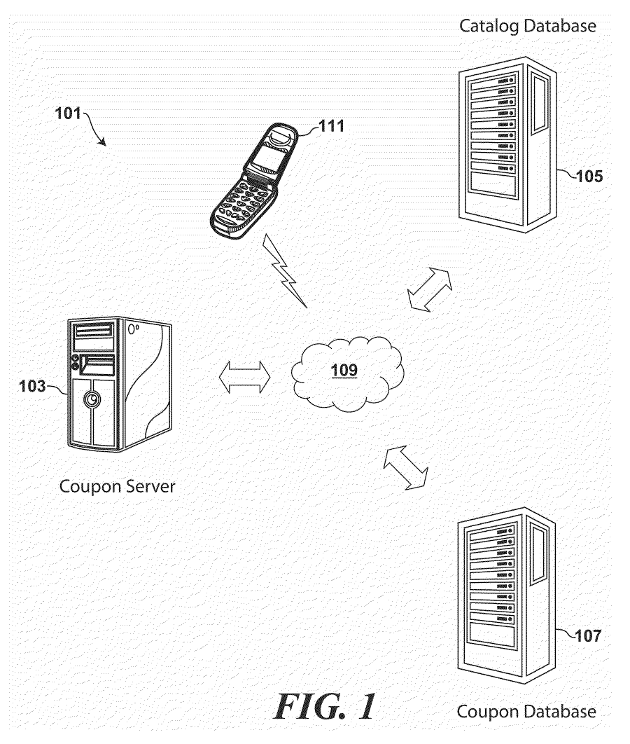

FIG. 1 illustrates a first particular, non-limiting embodiment of a system in accordance with the teachings herein and over which the methodologies described herein may be implemented. The system 101 depicted therein comprises a coupon server 103, a catalog database 105, a coupon database 107 and a mobile communications device 111 which are in communication with each other over a network 109. The network 111 may be, for example, a wide area network (WAN) such as the Internet. The mobile communications device 111 may be a cell phone, a smart phone, a personal digital assistant, or another such mobile communications device capable of communicating wirelessly over a network.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A system for presenting, to a user of a mobile device, coupons for products or services which are available at nearby stores, the system comprising:
a catalog database;
a coupon database containing a set of coupon offers, wherein each coupon offer is associated with a set of applicable items from the catalog database, and is further associated with a geographic region; and
a coupon server adapted to receive location and item information from the mobile device via a network, and being further adapted to (a) search through the coupon database, (b) evaluate coupons in the database for geographic relevance, (c) select any coupons determined to be geographically relevant, and (d) return the selected coupons to the mobile device.

2. The system of claim 1, further comprising:
a mobile device which is adapted to connect to the network, and which is further adapted to determine its location.

3. The system of claim 2, further comprising:
a browser, resident on the mobile device, which is adapted to allow a user of the mobile device to browse a catalog over the network.

4. The system of claim 2, where location is determined on the mobile device using the Global Positioning System.

5. The system of claim 2, where location is determined through the use of Cell Tower Triangulation using the known locations of one or more connected or nearby cell towers.

6. The system of claim 5, where the triangulation occurs on the mobile device.

7. The system of claim 5, where the triangulation occurs on a server computer.

8. The system of claim 1, where coupon offers in the coupon database are associated with a catalog identifier, and wherein applicability extends from the catalog node pointed to by the catalog identifier to each leaf level catalog item reachable from the identified node.

9. The system of claim 1, where coupon offers in the coupon database are associated with a geographic predicate that defines an area of interest, wherein the coupon server returns true when an input position is within the area of interest, and wherein the coupon server returns false when the input position is not within the area of interest.

10. The system of claim 9, where the geographic predicate contains a set of permissible geographic codes selected from the group consisting of country codes, state codes, and postal codes, and wherein the coupon server returns true if an input position is within an area represented by a permissible geographic code.

11. The system of claim 9, wherein the geographic predicate contains a set of polygons defined by points on the earth, and wherein the coupon server returns true if an input position is within an area defined by a polygon.

12. The system of claim 2, where a coupon is presented to the user as alphanumeric text displayed on the mobile device.

13. The system of claim 2, where a coupon is presented to the user as a graphic displayed on the mobile device.

14. The system of claim 13, wherein the graphic is a barcode.

15. The system of claim 1, further comprising:
a network adapted to support communication between the mobile device and a server computer.

16. The system of claim 1, wherein the catalog database contains a set of products or services organized as a tree, and wherein each node in the tree contains an identifier.

17. A method for presenting, to a user of a mobile device, coupons for products or services which are available at nearby stores, the method comprising:
receiving location information and item information from a mobile device via a network, wherein the location information relates to the location of the mobile device, and wherein the item information relates to an item of interest to a user of the mobile device;
evaluating coupons in a coupon database for geographic relevance and user interest relevance, wherein the geographical relevance is determined from the location information, and wherein the user interest relevance is determined from the item information; and
returning to the mobile device coupons meeting a predetermined geographic relevance and a predetermined user interest relevance.

18. The method of claim 17, wherein the location information identifies the location of the mobile device, and wherein the item information identifies an item or category of interest to a user of the mobile device.

19. The method of claim 18, wherein the item or category of interest to the user of the mobile device is determined from an item or category selected by the user.

20. The method of claim 18, wherein the item or category of interest to the user of the mobile device is selected from a catalog.

21. The method of claim 18, wherein the item or category of interest to the user of the mobile device is determined from an item or category browsed by the user.

22. A system for presenting, to a user of a mobile device, coupons for relevant products or services, wherein relevancy is determined through a context aware combination of location and product selection.

23. A method for presenting, to a user of a mobile device, coupons for relevant products or services, comprising:
determining the relevancy to the user of a coupon through a context aware combination of location and product selection.

24. A system for presenting, to a user of a mobile device, coupons for products or services which are available at nearby stores, the system comprising:
a network adapted to support communication between the mobile device and a server computer;
a mobile device which is adapted to connect to the network, and which is further adapted to determine its location;
a browser, resident on the mobile device, which is adapted to allow a user of the mobile device to browse a catalog over the network;
a catalog database containing of a set of products or services organized as a tree, wherein each node in the tree contains an identifier;
a coupon database containing a set of coupon offers, wherein each coupon offer is associated with a set of applicable items from the catalog database, and is further associated with a geographic region; and
a coupon server adapted to receive location and item information from the mobile device via the network, and being further adapted to (a) search through the coupon database, (b) evaluate coupons in the database for geographic relevance, (c) select any coupons determined to be geographically relevant, and (d) return the selected coupons to the mobile device.
